(19) United States
(12) Patent Application Publication
(10) Pub. No.: US 2014/0067163 A2
(43) Pub. Date: Mar. 6, 2014

(54) Vehicle Intelligent Key Device, Remote Control System, and Method for Driving a Passenger Vehicle

(71) Applicants: SHENZHEN BYD AUTO R&D COMPANY LIMITED, Shenzhen, Guangdong (CN); BYD COMPANY LIMITED, Shenzhen, Guangdong (CN)

(72) Inventors: Xiaowen DU, Shenzhen (CN); Yongzeng ZHANG, Shenzhen (CN); Yilin ZHONG, Shenzhen (CN); Bo FAN, Shenzhen (CN)

(21) Appl. No.: 13/857,781

(22) Filed: Apr. 5, 2013

(30) Foreign Application Priority Data
Apr. 6, 2012 (CN) 201210099997.1

(51) Int. Cl. G08C 17/02

(52) U.S. Cl. CPC G08C 17/02
USPC 701/2

(57) ABSTRACT

A passenger vehicle includes: a vehicle intelligent key device, configured to send a starting signal and a control signal; and a passenger vehicle, configured to receive the starting signal and the control signal, to start a remote control mode according to the starting signal, and to control the passenger vehicle according to the control signal, wherein the passenger vehicle comprises an automatic transmission and an electrical parking brake, the automatic transmission is configured to receive the control signal, and to control the electrical parking brake to disengage a parking cable of the passenger vehicle and to set a gearbox to a “Drive” state or a “Reverse” state when the passenger vehicle is in the remote control mode.

### CROSS-REFERENCE TO RELATED APPLICATION

This application claims priority to and benefit of Chinese Patent Application No. 201210099997.1, filed with the State Intellectual Property Office of P. R. China on Apr. 6, 2012, the entire contents of which are incorporated herein by reference.

### FIELD

The present disclosure generally relates to vehicular technologies and, more particularly, to a vehicle intelligent key device, a remote control system for driving a vehicle and a remote control method for driving a vehicle.

### BACKGROUND

More and more individuals and families use passenger vehicles as main transportation tools. It becomes more and more difficult to find a parking space as the number of vehicles increases. For densely populated cities, parking spaces for vehicles are not only in shortage but also becoming much smaller. Therefore, it is difficult for a driver to maneuver the vehicle in or out of the parking space. It is also difficult for the driver or a passenger to get in or off the vehicle when the vehicle is parked.

There is a need to control the vehicle to park or start the vehicle from outside, so that the driver does not need to get in or get off the vehicle in the narrow parking space.

### SUMMARY

According to some embodiments of the present disclosure, a remote control system for driving a vehicle is provided. The remote control system may comprise: a vehicle intelligent key device, configured to send a starting signal and a control signal; and a vehicle, configured to receive the starting signal and the control signal, to start a remote control mode according to the starting signal, and to control an operational state of the vehicle according to the control signal, wherein the vehicle comprises an automatic transmission and an electrical parking brake, the automatic transmission is configured to receive the control signal, and to control the electrical parking brake to disengage a parking cable of the vehicle, to feed back a state of the parking cable and to set a gearbox to a “Drive” state or a “Reverse” state when the vehicle is in the remote control mode.

According to some alternative embodiments of the present disclosure, a vehicle intelligent key device is provided. The vehicle intelligent key device may comprise: a starting key; a direction control key; a wireless communication module, configured to communicate with a vehicle wirelessly; and a control module, connected to the starting key, the direction control key and the wireless communication module respectively, configured to send a starting signal or a control signal to the vehicle when the starting key or the direction control key is activated.

According to still some alternative embodiments of the present disclosure, a remote control method for driving a vehicle is provided, the remote control method may comprise steps of: generating a starting signal and a control signal by a vehicle intelligent key device; sending the starting signal and the control signal to a vehicle; starting a remote control mode of the vehicle according to the starting signal; and controlling the vehicle to move forward or backward at a speed lower than a predetermined vehicle threshold speed according to the control signal when the vehicle is in the remote control mode.

The above summary of the present disclosure is not intended to describe each disclosed embodiment or every implementation of the present disclosure. The following figures and detailed description more particularly exemplify illustrative embodiments. Additional aspects and advantages of embodiments of present disclosure will be given in part in the following descriptions, and become apparent in part from the following descriptions, or be learned from the practice of the embodiments of the present disclosure.

### BRIEF DESCRIPTION OF THE DRAWINGS

FIG. 1 is a block diagram of a remote control system for driving a vehicle according to an embodiment of the present disclosure;

FIG. 2 is a block diagram of a remote control system in a remote starting mode according to an embodiment of the present disclosure;

FIG. 3 is a block diagram of a remote control system in a remote turning mode according to an embodiment of the present disclosure;

FIG. 4 is a block diagram of a vehicle intelligent key device according to an embodiment of the present disclosure;

FIG. 5 is a schematic view of a control panel of a vehicle intelligent key device according to an embodiment of the present disclosure;

FIG. 6 is a flow chart of a remote control process for driving a vehicle according to an embodiment of the present disclosure;

FIGS. 7A-7B depict a flow chart of a process for controlling the vehicle to start a remote control mode according to an embodiment of the present disclosure;

FIGS. 8A-8B depict a flow chart of a process for controlling the vehicle to move forward according to an embodiment of the present disclosure;

FIGS. 9A-9B depict a flow chart of a process for controlling the vehicle to reverse according to an embodiment of the present disclosure;

FIG. 10 is a flow chart of a process for controlling the vehicle to turn left or right according to an embodiment of the present disclosure;

FIG. 11 is a flow chart of a process for controlling the vehicle to quit the remote control mode according to an embodiment of the present disclosure; and

FIG. 12 is a flow chart of a process for controlling the vehicle to quit the remote control mode according to another embodiment of the present disclosure.

### DETAILED DESCRIPTION

Reference will be made in detail to embodiments of the present disclosure. The embodiments described herein with reference to accompanying drawings are explanatory and illustrative, which are used to generally describe the present disclosure. The embodiments shall not be construed to limit the present disclosure. The same or similar elements and the elements having same or similar functions are denoted by like reference numerals throughout the descriptions.

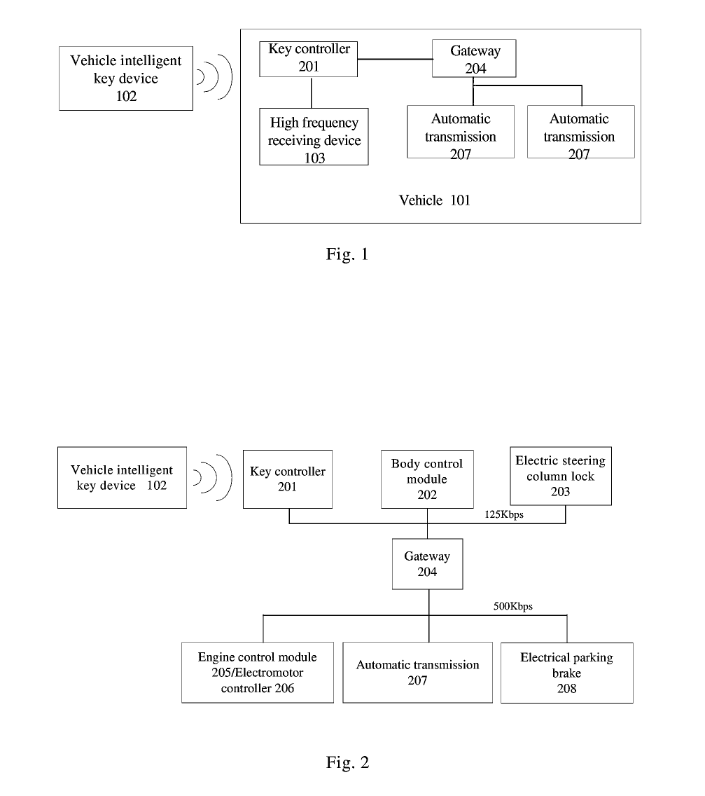

The remote control system according to embodiments of the present disclosure will be described in detail with reference to FIGS. 1-3 below.

FIG. 1 is a block diagram of a remote control system for driving a vehicle according to an embodiment of the present disclosure. As shown in FIG. 1, the remote control system according to embodiments of the present disclosure comprises a vehicle 101 and a vehicle intelligent key device 102. The vehicle intelligent key device 102 is configured to send a starting signal and a control signal to the vehicle 101. The vehicle 101 is configured to receive the starting signal and the control signal sent from the vehicle 101, to start a remote control mode according to the starting signal, and to control an operational state of the vehicle 101 according to the control signal. Therein, controlling the operational state of the vehicle 101 may comprise controlling a steering system, a speed control system, and a braking system of the vehicle 101.

Furthermore, as shown in FIG. 1, the vehicle 101 comprises an automatic transmission 207 and an electrical parking brake (EPB) 208. The automatic transmission 207 is configured to receive the control signal, to control the electrical parking brake 208 to disengage a parking cable and to feed back a state of the parking cable, and to set a gearbox to a “Drive” gear or a “Reverse” gear when the vehicle is in the remote control mode.

In one example of the present disclosure, when the automatic transmission 207 receives a remote forward signal and detects that the engine and/or the power system are in the remote control mode, the automatic transmission 207 may control the electrical parking brake 208 to disengage the parking cable, to feed back a state of the parking cable, and to set the gearbox to the “Drive” gear. The vehicle 101 then moves forward at a speed lower than the predetermined vehicle speed (for example, 2 km/h).

In another embodiment of the present disclosure, as shown in FIG. 1, when the automatic transmission 207 receives a remote backward signal and detects that the engine and/or the power system are in the remote control mode, the automatic transmission 207 controls the electrical parking brake 208 to disengage the parking cable, to feed back the state of the parking cable, and to set the gearbox to the “Reverse” gear. The vehicle 101 then moves backward at a speed lower than the predetermined vehicle speed (for example, 2 km/h).

In one example of the present disclosure, the automatic transmission 207 is a dual clutch transmission (DCT).

FIG. 2 is a block diagram of a remote control system in a remote starting mode according to an embodiment of the present disclosure. As shown in FIGS. 1 and 2, if the vehicle 101 is a fuel vehicle, the vehicle 101 may further comprise a key controller 201, a body control module (BCM) 202, an electric steering column lock (ECL) 203, a gateway 204, and an engine control module (ECM) 205.

As shown in FIG. 2, if the vehicle 101 is an electric vehicle, the vehicle 101 may further comprise a key controller 201, a body control module 202, an electric steering column lock 203, a gateway 204, and an electromotor controller 206. The key controller 201, the body control module 202, the electric steering column lock 203, the engine control module (ECM) 205/electromotor controller 206, the automatic transmission 207, and the electrical parking brake 208 are configured to communicate with one another through the gateway 204. Specifically, the key controller 201 may receive the starting signal and the control signal sent from the vehicle intelligent key device 102, and generate a remote starting signal or a remote control signal according to the starting signal and the control signal. In one embodiment of the present disclosure, the starting signal may be a high-frequency starting signal and the control signal may be a high-frequency control signal.

In one embodiment of the present disclosure, as shown in FIG. 1, the vehicle 101 may further comprise a high-frequency receiving device 103 configured to receive the high-frequency starting signal and the high-frequency control signal sent from the vehicle intelligent key device 102, to demodulate the high-frequency starting signal and the high-frequency control signal so as to obtain the staring signal and the control signal, and to send the starting signal and the control signal to the key controller 201.

The body control module 202 is configured to receive the remote starting signal and the remote control signal sent from the key controller 201, and to control the vehicle 101 to power on and to start the remote control mode according to the remote starting signal and to generate an unlocking signal according to the remote control signal.

The electric steering column lock 203 is configured to receive the unlocking signal sent from the body control module 202 and to unlock a steering wheel of the vehicle 101 according to the unlocking signal.

The gateway 204 is configured to communicate with the key controller 201, the body control module 202, and the electric steering column lock 203. In particular, the gateway 204 is configured to realize a high/low speed network communication within the vehicle 101. For example, the high speed may be 500 Kbps (bit per second); and the low speed may be 125 Kbps.

The engine control module 205 is configured to communicate with the gateway 204 and to control an engine of the vehicle 101 to start according to the remote starting signal transmitted by the gateway 204.

The electromotor controller 206 is configured to control the power system of the vehicle 101 to start according to the remote starting signal transmitted by the gateway 204. The automatic transmission 207 is configured to communicate with the gateway 204, and to control a gearbox of the vehicle 101 to switch to different gears and to generate a parking control signal according to the remote control signal transmitted by the gateway 204.

The electrical parking brake 208 is configured to communicate with the gateway 204 and to control the vehicle 101 to park according to the parking control signal transmitted by the gateway 204.

In one embodiment of the present disclosure, as shown in FIG. 2, the key controller 201 is further configured to detect whether the vehicle intelligent key device 102 is outside the vehicle 101 after receiving the starting signal and the control signal, and to send the remote starting signal and the remote control signal to the body control module 202 when the vehicle intelligent key device 102 is outside the vehicle 101.

The body control module 202 is further configured to detect a state of the electrical parking brake 208 and the gearbox of the vehicle. When the state of the electrical parking brake 208 is “normal” and the gearbox of the vehicle is set to a “Park” gear, for the fuel vehicle, the engine control module 205 and the key controller 201 perform a pairing operation. If the engine control module 205 and the key controller 201 are paired, the engine control module 205 controls the engine to start.

For the electric vehicle, the electromotor controller 206 and the key controller 201 perform the pairing operation. If the electromotor 206 and the key controller are paired, the electromotor 206 controls the power system of the vehicle 101 to start. After the engine/power system is started, the vehicle 101 enters a remote control mode.

In some embodiment of the present disclosure, the body control module 202 is configured to control the engine and/or the power system to quit the remote control mode if any one of the following conditions is satisfied:
1) no remote control signal indicating the vehicle 101 is in the remote control mode is detected by the body control module 202 during a first predetermined time period;
2) no remote control mode signal is detected by the body control module 202 during a second predetermined time period;
3) a quitting remote control mode signal is detected by the body control module 202;
4) a vehicle door is detected by the body control module 202 to be open;
5) a brake pedal or an accelerator pedal is detected by the body control module 202 to be pressed down;
6) a vehicle speed is detected to be higher than a predetermined threshold speed or the vehicle speed is not detected by the body control module 202;
7) a remote unlocking signal or a micro switch unlocking signal sent from the key controller 201 is received by the body control module 202.

In one embodiment of the present disclosure, the first predetermined time period may be 10 minutes, the second predetermined time period may be 2 seconds, and the predetermined threshold speed may be 2 km/h. The numerical value of the first predetermined time period, the second predetermined time period and the predetermined vehicle threshold speed according to the embodiment described herein are explanatory and illustrative, which are used to generally describe the present disclosure. It shall not be construed to limit the present disclosure. The numerical values of the first predetermined time period, the second predetermined time period, and the predetermined threshold speed may be other numerical values depending on driving habits of different users.

In some embodiments of the present disclosure, the automatic transmission 207 may be configured to send an engaging signal for engaging a parking cable of the electrical parking brake 208 and to set the gearbox to the “Park” gear when the engine and/or the power system quits the remote control mode.

In one example of the present disclosure, the remote control signal may be any one of a remote forward signal, a remote backward signal, and a remote turning signal. The remote forward signal is configured to control the vehicle to move forward, the remote backward signal is configured to control the vehicle to reverse, and the remote turning signal is configured to control the vehicle to turn left or right.

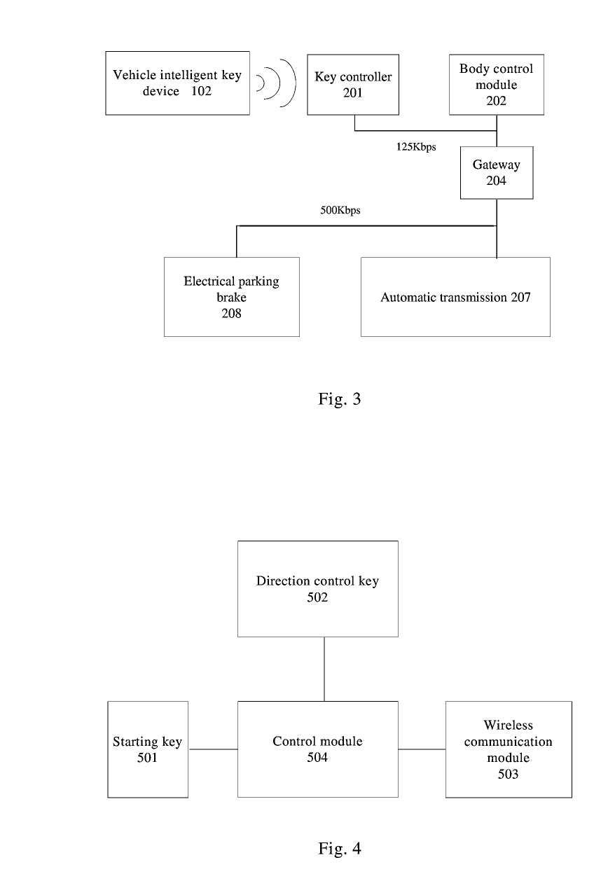

FIG. 3 is a remote control system in a remote turning mode according to an embodiment of the present disclosure. As shown in FIG. 3, the vehicle may further comprise an electric power steering module (EPS) 401 and an angle sensor 402.

The electric power steering module (EPS) 401 is configured to receive the remote turning signal sent from the key controller 201 and to control the steering wheel of the vehicle 101 to rotate when the power system is in the remote control mode. The angle sensor 402 is configured to detect the rotation angle of the steering wheel and to feed back the rotation angle to the electric power steering module 401. Then the electric power steering module 401 controls a steering column of the vehicle 101 to turn left or right at a certain speed.

With the remote control system according to embodiments of the present disclosure, users may control the vehicle to move forward or backward at a speed lower than the predetermined vehicle speed (for example, 2 km/h), or control the vehicle to turn left or right within a visual range (for example, 10 meters) outside the vehicle. The operation of the remote control system is also simple and easy. Therefore, it is very convenient for a user to park or take a vehicle in a narrow space.

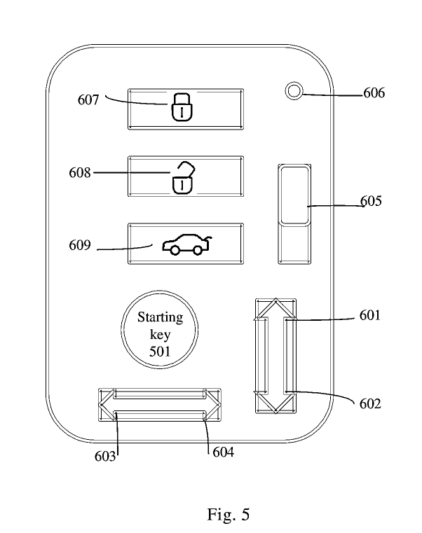

Referring to FIGS. 4 and 5, the vehicle intelligent key device according to embodiments of a second broad aspect of the present disclosure will be described in detail.

FIG. 4 is a block diagram of a vehicle intelligent key device according to an embodiment of the present disclosure. As shown in FIG. 4, in embodiments of the present disclosure, the vehicle intelligent key device may comprise a starting key 501; a direction control key 502; a wireless communication module 503 and a control module 504. The wireless communication module 503 is configured to communicate with the vehicle 101 wirelessly. The control module 504 is electronically connected to the starting key 501, the direction control key 502, and the wireless communication module 503, and configured to send a starting signal or a control signal to the vehicle when the starting key 501 or the direction control key 502 is activated.

When a user activates the starting key 501 by, for example, pressing down and holding the starting key 501 for a time period greater than a third predetermined time period, the vehicle intelligent key device may modulate relevant information and send a first high-frequency starting signal. The high-frequency receiving device of the vehicle may receive the first high-frequency starting signal and then send a starting signal to a key controller of the vehicle after demodulating the first high-frequency starting signal. The key controller authenticates the starting signal, and then sends out a “starting” message to control the vehicle to start. In one embodiment of the present disclosure, the third predetermined time period may be 2 seconds.

In contrast, when the user presses down and holds the starting key 501 for a short period of time (e.g., a time period less than the third predetermined time period), the vehicle intelligent key device may modulate relevant information and send a second high-frequency starting signal. Then the high-frequency receiving device of the vehicle may receive the second high-frequency starting signal and send an off signal to the key controller of the vehicle after demodulating the second high-frequency starting signal. The key controller authenticates the off signal, and then sends out an “off” message to control the vehicle to be turned off.

FIG. 5 is a schematic view of a control panel of the vehicle intelligent key device according to an embodiment of the present disclosure. As shown in FIG. 5, in one embodiment of the present disclosure, the direction control key 502 may comprise at least one of a left turning key 603, a right turning key 604, a forward key 601 and a backward key 602.

In one embodiment of the present disclosure, when the user activates the forward key 601 by, for example pressing down the forward key 601, the vehicle intelligent key device may modulate relevant information and send a high-frequency forward signal. Then, the high-frequency receiving device of the vehicle may receive the high-frequency forward signal and send a forward-signal to the key controller of the vehicle after demodulating the high-frequency forward signal. The key controller authenticates the forward signal, and then sends out a “Driving” message to control the vehicle to move forward at a low speed. In one embodiment of the present disclosure, the vehicle may move forward at a speed lower than 2 km/h. If the user releases the forward key 601, the vehicle stops.

In one embodiment of the present disclosure, when the user activates the backward key 602 by, for example, pressing down the backward key 602, the vehicle intelligent key device may modulate relevant information and send a high-frequency backward signal. Then the high-frequency receiving device of the vehicle may receive the high-frequency backward signal and send a backward signal to the key controller of the vehicle after demodulating the high-frequency backward signal. The key controller authenticates the backward signal, and then sends out a “Reverse” message to control the vehicle to reverse at a low speed. In one embodiment of the present disclosure, the vehicle may reverse at a speed lower than 2 km/h. If the user releases the backward key 602, the vehicle stops.

In one embodiment of the present disclosure, when the user activates the left turning key 603 by, for example, pressing down the left turning key 603, the vehicle intelligent key device may modulate relevant information and send a high-frequency left turning signal. Then the high-frequency receiving device of the vehicle may receive the high-frequency left turning signal and send a left turning signal to the key controller of the vehicle after demodulating the high-frequency left turning signal. The key controller authenticates the left turning signal, and then sends out a “left turning” message to control a steering wheel of the vehicle to turn left. If the user releases the left turning key 603, the vehicle stops turning left.

In one embodiment of the present disclosure, when the user activates the right turning key 604 by, for example, pressing down the right turning key 604, the vehicle intelligent key device may modulate relevant information and send a high-frequency right turning signal. Then the high-frequency receiving device of the vehicle may receive the high-frequency right turning signal and send a right turning signal to the key controller of the vehicle after demodulating the high-frequency right turning signal. The key controller authenticates the right turning signal, and then sends out a “right turning” message to control a steering wheel of the vehicle to turn right. If the user releases the right turning key 604, the vehicle stops turning right.

The direction control key 502 may be effective only when the starting key 501 is activated to start a remote control mode. The left turning key 603, the right turning key 604, the forward key 601 and the backward key 602 may not be operated at the same time. For example, the user may not be able to control the vehicle to turn left or right when controlling the vehicle to move forward or backward through the forward key 601 or the backward key 602. Thus, it may be invalid to press down the left turning key 603 or the right turning key 604 during the forward or backward movement of the vehicle. Similarly, the user may not be able to control the vehicle to move forward or backward when controlling the vehicle to turn left or right through the left turning key 603 or the right turning key 604. Thus, it may be invalid to press down the forward key 601 or the backward key 602 during the left or right turning of the vehicle.

Referring to FIG. 5, the vehicle intelligent key device according to embodiments of the present disclosure may further comprise a locking key 607, an unlocking key 608, a trunk opening key 609, and a holding key 605.

In one embodiment of the present disclosure, the locking key 607 is electronically connected to the control module 504. The control module 504 is configured to control the wireless communication module 503 to send a locking signal to the vehicle when the locking key 607 is activated. In other words, when the locking key 607 is activated by the user, the vehicle intelligent key device may modulate relevant information and send a high-frequency locking signal. Then the high-frequency receiving device of the vehicle may receive the high-frequency locking signal; and send the locking signal to the key controller of the vehicle after demodulating the high-frequency locking signal. The key controller authenticates the locking signal, and sends out a “remote locking” message. Thus, before a remote control mode of the vehicle, the vehicle can be locked according to the “remote locking” message so as to avoid a mis-operation.

In one embodiment of the present disclosure, the unlocking key 608 is electronically connected to the control module 504. The control module 504 is configured to control the wireless communication module 503 to send an unlocking signal to the vehicle when the unlocking key 608 is activated. In other words, when the unlocking key 608 is activated by the user, the vehicle intelligent key device may modulate relevant information and send a high-frequency unlocking signal. Then the high-frequency receiving device of the vehicle may receive the high-frequency unlocking signal and send the unlocking signal to the key controller of the vehicle after demodulating the high-frequency unlocking signal. The key controller authenticates the unlocking signal, and sends out a “remote unlocking” message. Thus, the vehicle may be unlocked to quit the remote control mode by activating the unlocking key 608 to unlock the vehicle.

Similarly, in one embodiment of the present disclosure, the trunk opening key 609 is electronically connected to the control module 504. The control module 504 is configured to control the wireless communication module 503 to send a trunk opening signal to the vehicle when the trunk opening key 609 is activated. In particular, when the trunk opening key 609 is activated by the user, the vehicle intelligent key device may modulate relevant information and send a high-frequency trunk opening signal. Then the high-frequency receiving device of the vehicle may receive the high-frequency trunk opening signal; and then send the trunk opening signal to the key controller of the vehicle after demodulating the high-frequency trunk opening signal. The key controller authenticates the signal, and sends out a “remote trunk opening” message to cause the trunk to open.

In one embodiment of the present disclosure, the holding key 605 is connected to the control module 504, and the control module 504 is configured to lock the keys of the vehicle intelligent key device, including the starting key 501, the direction control key 502, the locking key 607, the unlocking key 608, and the trunk opening key 609, when the holding key 605 is activated. In other words, when the holding key 605 is activated by the user, the vehicle intelligent key device may modulate relevant information and send a high-frequency holding signal. Then the high-frequency receiving device of the vehicle may receive the high-frequency holding signal and send the holding signal to the key controller of the vehicle after demodulating the high-frequency holding signal. The key controller authenticates the holding signal, and sends out a “holding” message to control the vehicle not to execute any action according to the signal sent from the vehicle intelligent key device (for example, the starting signal or the direction controlling signal) when the vehicle is already in a desired condition (for example, the vehicle is already parked in a given location). Thus, mis-operation may be avoided.

In some embodiments of the present disclosure, the vehicle intelligent key device may further comprise an indicator 606 configured to indicate various statuses of the vehicle intelligent key device. The indicator 606 may be red, blue, green, yellow, or any other colors known in the art. Furthermore, the indicator 606 may be activated to emit light in a chosen color for a fourth predetermined time period whenever the vehicle intelligent key device is operated to send out a signal.

In one embodiment of the present disclosure, the fourth predetermined time period may be 250 milliseconds. When the indicator 606 emits light, it indicates that the vehicle intelligent key device operates normally. When the indicator 606 fails to emit light, it may indicate that the vehicle intelligent key device is low on power or the signal is too weak.

In one embodiment of the present disclosure, the vehicle intelligent key device may further comprise a transponder (not shown) configured to communicate with the vehicle when the wireless communication module 503 is interfered by other signals or environmental factors. When the power of the vehicle intelligent key device is low or zero, the transponder may also provide communications between the vehicle intelligent key device and the vehicle.

With the vehicle intelligent key device according to the present disclosure, users may control the vehicle to start according to the activation of the starting key 501, to move forward/backward and turn left/right at a low speed within a visual range (for example, about 10 meters around the vehicle 101) according to the activation of the direction control key 502 of the vehicle. Thus, it is possible to realize various controls for the vehicle outside the vehicle, and it is easy and convenient for users to park or take a vehicle in narrow spaces. The operation of the vehicle intelligent key device is also simple and convenient.

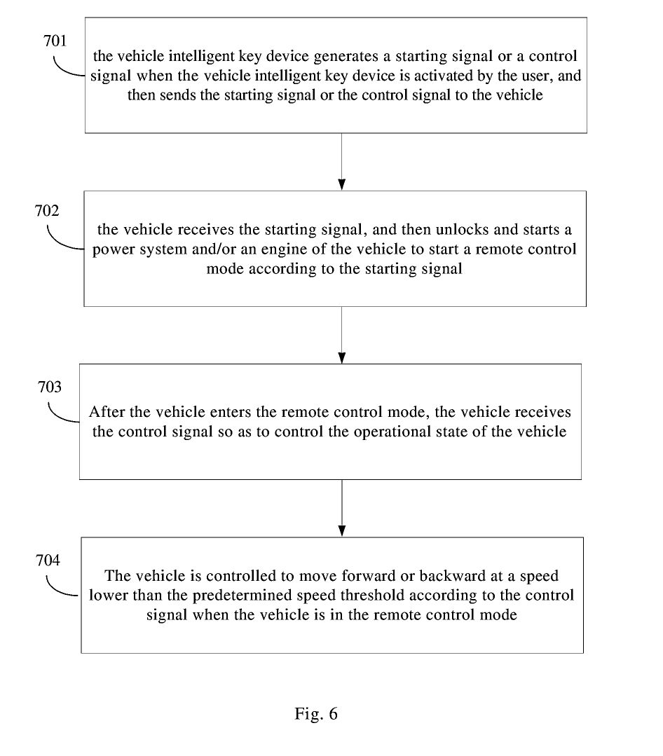

Referring to FIGS. 6-12, the remote control method for driving a vehicle according to embodiments of a third broad aspect of the present disclosure will be described in detail.

According to embodiments of the present disclosure, the remote control method may comprise steps of: generating a starting signal and a control signal by a vehicle intelligent key device; sending the starting signal and the control signal to a vehicle; starting a remote control mode of the vehicle according to the starting signal; and controlling the vehicle to move forward or backward at a speed lower than a predetermined threshold speed according to the control signal when the vehicle is in the remote control mode.

FIG. 6 is a flow chart of a remote control process 700 for driving a vehicle according to an embodiment of the present disclosure. As shown in FIG. 6, in embodiments of the present disclosure, the remote control method may comprise the following steps.

At step 701, the vehicle intelligent key device generates a starting signal or a control signal when the vehicle intelligent key device is activated by the user, and then sends the starting signal or the control signal to the vehicle.

At step 702, the vehicle receives the starting signal, and then unlocks and starts a power system and/or an engine of the vehicle to start a remote control mode according to the starting signal.

At step 703, after the vehicle enters the remote control mode, the vehicle receives the control signal so as to control the operational state of the vehicle. Controlling the operational state of the vehicle may comprise controlling the steering system, the speed control system and the braking system of the vehicle.

At step 704, the vehicle is controlled to move forward or backward at a speed lower than the predetermined threshold speed according to the control signal when the vehicle is in the remote control mode.

In one embodiment of the present disclosure, the starting signal may be a high-frequency starting signal, and the control signal may be a high-frequency control signal.

In one embodiment of the present disclosure, the high-frequency receiving device of the vehicle may receive the high-frequency starting signal and the high-frequency control signal sent from the vehicle intelligent key device, and then send the starting signal and the control signal to the key controller of the vehicle after demodulating the high-frequency starting signal and the high-frequency control signal. The key controller generates a remote starting signal and a remote control signal according to the starting signal and the control signal. The remote control signal may be a remote forward signal, a remote backward signal, or a remote turning signal.

In addition, the key controller of the vehicle may detect whether the vehicle intelligent key device is outside the vehicle after receiving the starting signal or the control signal, and if yes, the key controller may send the remote starting signal or the remote control signal to a body control module of the vehicle so as to start a remote control mode of the vehicle and to control the operational state of the vehicle.

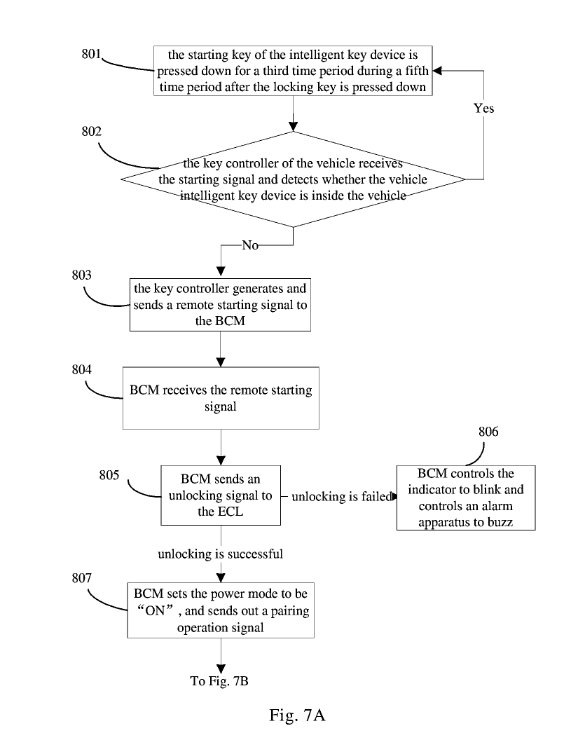

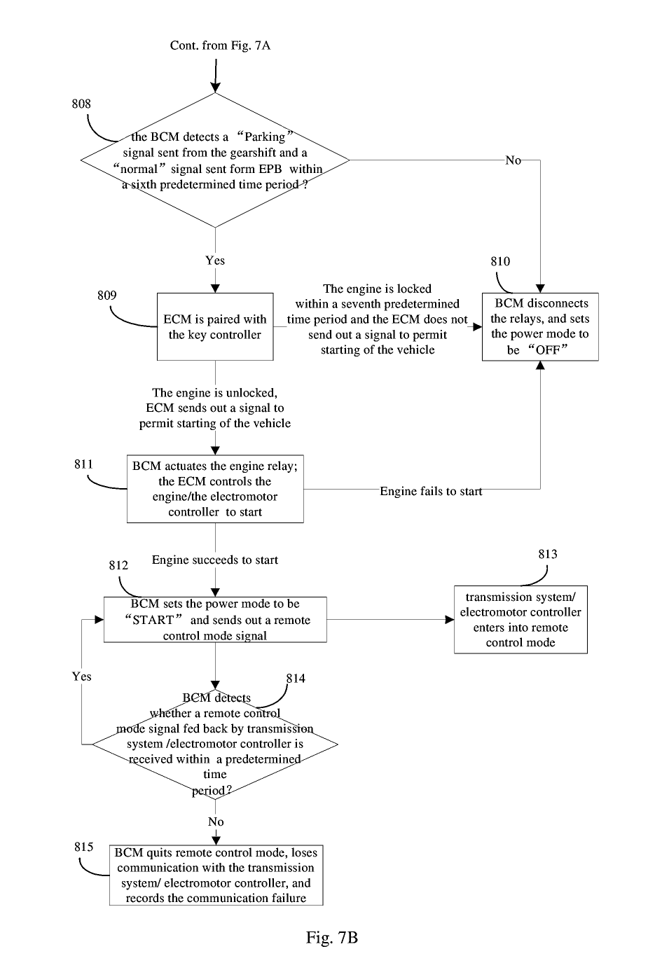

FIGS. 7A-7B depict a flow chart of a process 800 for controlling the vehicle to start the remote control mode according to an embodiment of the present disclosure. As shown in FIGS. 7A-7B, controlling the vehicle to start the remote control mode (i.e. the step 702 of FIG. 6) may comprise the following steps.

At step 801, the starting key of the intelligent key device is pressed down for a third time period during a fifth time period after the locking key is pressed down. Specifically, the locking key is pressed down by the user so as to keep the vehicle in the locking state. During the fifth time period after the locking key is pressed down, the starting key is pressed down for a third time period. Thus, the intelligent key device sends a starting signal to the vehicle. In one embodiment, the third time period may be 2 seconds, the fifth time period may be 5 seconds.

At step 802, the key controller of the vehicle receives the starting signal and detects whether the vehicle intelligent key device is inside the vehicle. If yes, the process 800 returns to 801; if no, the process 800 executes the step 803.

At step 803, the key controller generates a remote starting signal according to the starting signal and sends the remote starting signal to the body control module.

At step 804, the body control module receives the remote starting signal sent from the key controller and detects that all of the vehicle doors, the forward hatches and the trunk are locked. That is, the vehicle is in a burglary prevention setting or a burglary prevention state.

At step 805, the body control module sends an unlocking signal to an electric steering column lock. If the unlocking fails, the process 800 executes step 806, if the unlocking is successful, the process 800 executes step 807.

At step 806, the body control module controls the indicator of the starting key to blink and controls an alarm apparatus to buzz. For example, the body control module feeds back a failed unlocking signal to the vehicle intelligent key device and controls an orange indicator of the starting key to blink and the alarm apparatus to buzz one time.

At step 807, the body control module sets the power mode to be “ON,” and sends out a pairing operation signal to the engine control module. For the fuel vehicle, the body control module actuates relays, such as an ACC relay, an IG1 relay and an IG2 relay; sets the power mode to be “ON,” and sends out a pairing operation signal.

At step 808, the body control module detects whether a “Parking” signal sent from the gearshift and a “normal” signal sent from the electrical parking brake are received within a sixth predetermined time period. If yes, execute step 809; if no, execute step 810. In other words, if the body control module detects the “Parking” signal sent from the gearshift and the “normal” signal sent from electrical parking brake within the sixth predetermined time period (counting from the time when the IG relay is actuated), the process 800 executes step 809, otherwise, the process 800 executes step 810. In one embodiment, the sixth predetermined time period may be 1 second.

At step 809, the engine control module is paired with the key controller. If the engine control module and the key controller are paired, the burglary prevention of the engine is removed, the engine control module sends out a signal to permit starting of the vehicle, and the process 800 then executes step 811; if the burglary prevention of the engine is not removed within a seventh predetermined time period (for example, 2 seconds, counting from the time when the pairing operation signal is sent out) and the engine control module does not send out a signal to permit starting of the vehicle, it is indicated that the pairing operation is failed, the process 800 then executes step 810. For the electric vehicle, when the pairing operation is successful, the power system of the vehicle is unlocked.

At step 810, the body control module disconnects the ACC relay, the IG1 relay and the IG2 relay, and sets the power mode to be “OFF.”

At step 811, the body control module actuates an engine relay; and the engine control module controls the engine (for the fuel vehicle) to ignite and start. If the engine fails to start, then execute step 810; otherwise execute step 812. For the electric vehicle, the electromotor controller controls the vehicle to start.

At step 812, the body control module sets the power mode to be “START” and sends out a remote control mode signal.

At step 813, the transmission system (for the fuel vehicle)/the electromotor controller (for the electric vehicle) enters a remote control mode.

At step 814, the body control module detects whether the remote control mode signal fed back by the transmission system (for the fuel vehicle)/the electromotor controller (for the electric vehicle) is received within a predetermined time period (for example, 2 seconds). If yes, the process 800 returns to step 812; if not, the process 800 then executes step 815.

At step 815, the body control module quits the remote control mode, loses communication with the transmission system (for the fuel vehicle)/the electromotor controller (for the electric vehicle) and records the communication failure.

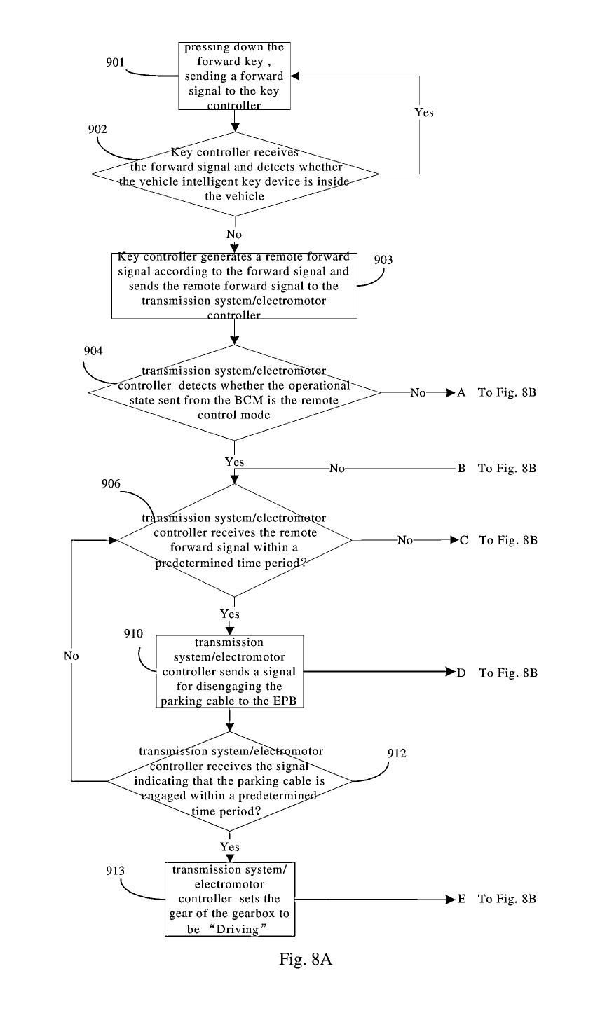

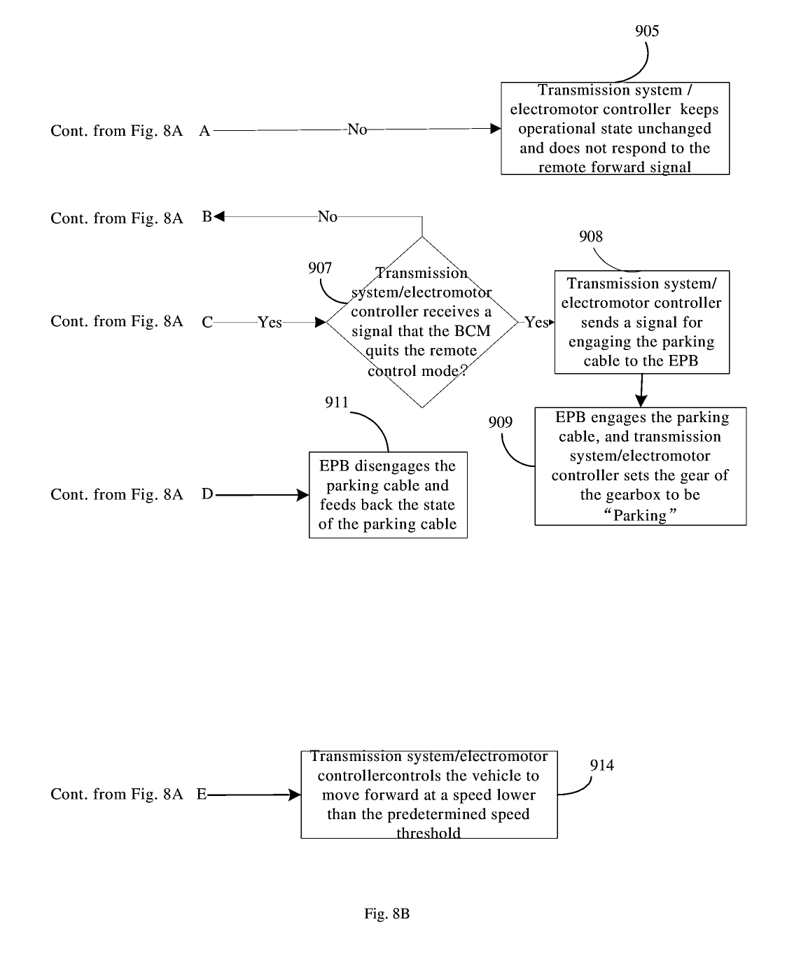

FIGS. 8A and 8B show a flow chart of a process 900 for controlling the vehicle to move forward according to an embodiment of the present disclosure. As shown in FIGS. 8A and 8B, according to one embodiment of the present disclosure, after the vehicle enters the remote control mode, controlling the vehicle to move forward further comprises the following steps.

At step 901, the forward key of the vehicle intelligent key device is pressed down, and a forward signal is sent to the key controller of the vehicle.

At step 902, the key controller receives the forward signal and detects whether the vehicle intelligent key device is inside the vehicle. If yes, the process 800 returns to step 901; if no, the process 900 then executes step 903.

At step 903, the key controller generates a remote forward signal according to the forward signal and sends the remote forward signal to the transmission system (for the fuel vehicle)/the electromotor controller (for the electric vehicle).

At step 904, the transmission system (for the fuel vehicle)/the electromotor controller (for the electric vehicle) detects whether the operational state sent from the body control module is the remote control mode. If yes, the process 900 then executes step 906; if no, the process 900 then executes step 905.

At step 905, the transmission system (for the fuel vehicle)/the electromotor controller (for the electric vehicle) keeps the operational state unchanged and does not respond to the remote forward signal.

At step 906, it is detected whether the transmission system (for the fuel vehicle)/the electromotor controller (for the electric vehicle) receives the remote forward signal sent from the key controller within a predetermined time period (for example, 100 ms). If no, the process 900 then executes step 907; if yes, the process 900 then executes step 910.

At step 907, it is detected whether the transmission system (for the fuel vehicle)/the electromotor controller (for the electric vehicle) receives a signal that the body control module quits the remote control mode. If yes, the process 900 then executes step 908; if no, the process 900 then returns to step 906.

At step 908, the transmission system (for the fuel vehicle)/the electromotor controller (for the electric vehicle) sends a signal for engaging the parking cable to the electrical parking brake.

At step 909, the electrical parking brake engages the parking cable, and the transmission system (for the fuel vehicle)/the electromotor controller (for the electric vehicle) sets the gearbox to the “Park” gear.

At step 910, the transmission system (for the fuel vehicle)/the electromotor controller (for the electric vehicle) sends a signal for disengaging the parking cable to the electrical parking brake.

At step 911, the electrical parking brake disengages the parking cable and feeds back the state of the parking cable.

At step 912, it is detected whether the transmission system (for the fuel vehicle)/the electromotor controller (for the electric vehicle) receives the signal indicating that the parking cable is disengaged within a predetermined time period such as 2 seconds. If yes, the process 900 then executes step 913, if no, the process 900 returns to step 906.

At step 913, the transmission system (for fuel vehicle)/electromotor controller (for electric vehicle) sets the gearbox to the “Drive” gear.

At step 914, the transmission system (for the fuel vehicle)/the electromotor controller (for the electric vehicle) controls the vehicle to move forward at a speed lower than the predetermined threshold speed (for example, 2 km/h).

Briefly, when a user presses down the forward key, the gearbox changes to the “Drive” gear, the parking cable of the electrical parking brake is disengaged, and the vehicle moves forward. If the user releases the forward key, the parking cable of the electrical parking brake is engaged; the gearbox is set to the “Park” gear, and the vehicle stops.

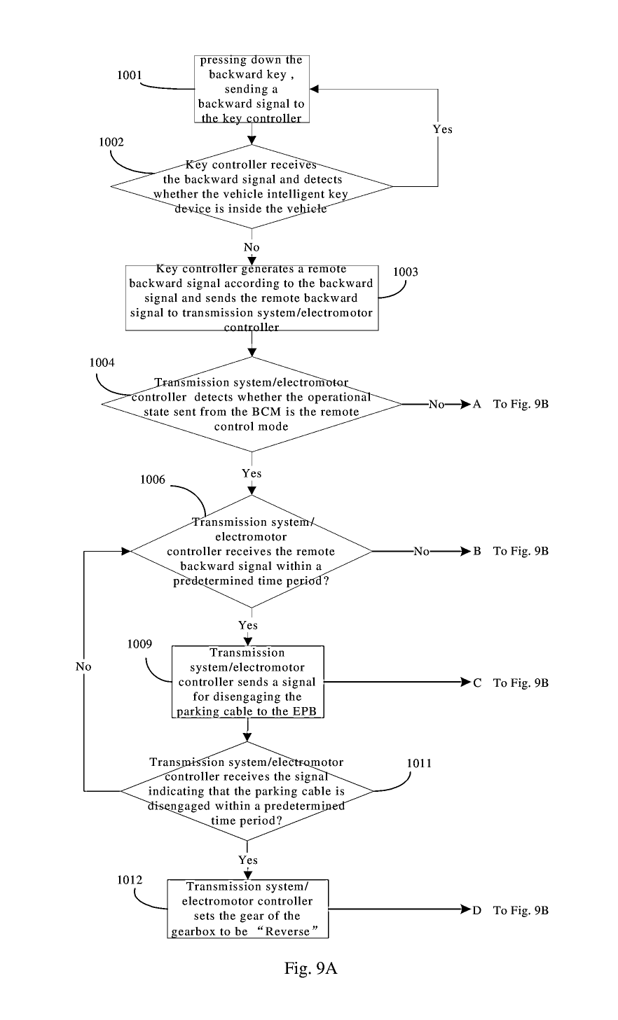

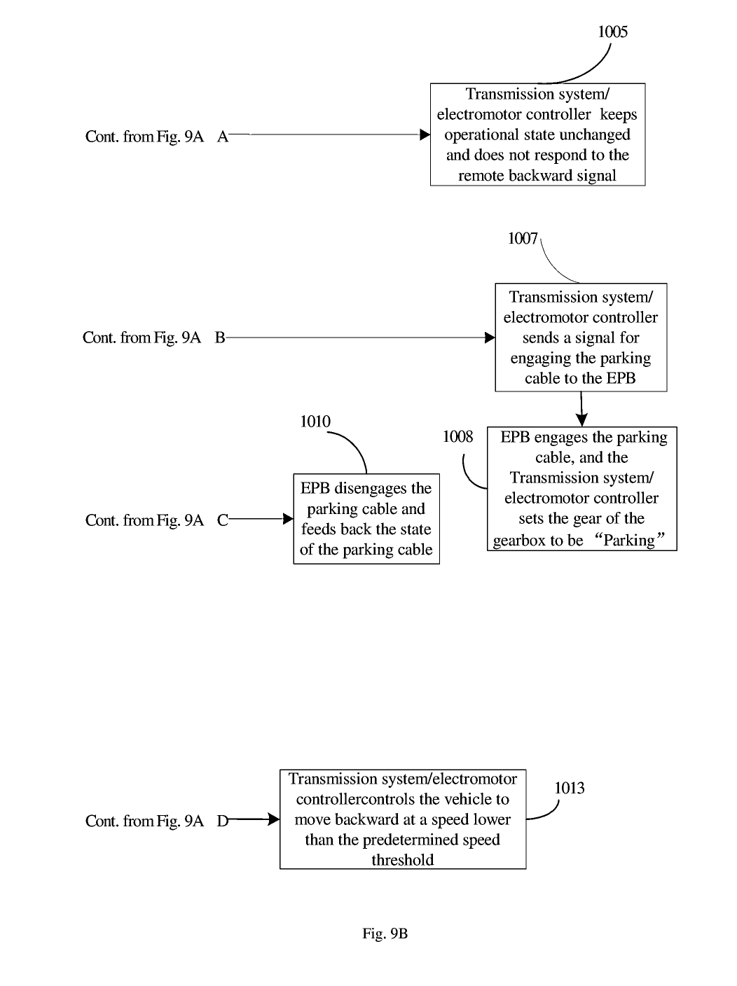

FIGS. 9A and 9B show a flow chart of a process 1000 controlling the vehicle to reverse according to an embodiment of the present disclosure. As shown in FIGS. 9A and 9B, according to one embodiment of the present disclosure, after the vehicle enters the remote control mode, controlling the vehicle to reverse further comprises the following steps.

At step 1001, the backward key of the vehicle intelligent key device is pressed down, and a backward signal is sent to the key controller of the vehicle.

At step 1002, the key controller receives the backward signal and detects whether the vehicle intelligent key device is inside the vehicle. If yes, the process 1000 returns to step 1001, if no, the process 1000 then executes step 1003.

At step 1003, the key controller generates a remote backward signal according to the backward signal and sends the remote backward signal to the transmission system (for the fuel vehicle)/the electromotor controller (for the electric vehicle).

At step 1004, the transmission system (for the fuel vehicle)/the electromotor controller (for the electric vehicle) detects whether the operational state sent from the body control module is the remote control mode. If yes, the process 1000 executes step 1006; if no, the process 1000 then executes step 1005.

At step 1005, the transmission system (for the fuel vehicle)/the electromotor controller (for the electric vehicle) keeps the operational state unchanged and does not respond to the remote backward signal.

At step 1006, it is detected whether the transmission system (for the fuel vehicle)/the electromotor controller (for the electric vehicle) receives the remote backward signal sent from the key controller within a predetermined time period (for example, 100 ms). If no, execute step 1007; if yes, then execute step 1009.

At step 1007, the transmission system (for the fuel vehicle)/the electromotor controller (for the electric vehicle) sends a signal for engaging the parking cable to the electrical parking brake.

At step 1008, the electrical parking brake engages the parking cable, and the transmission system (for the fuel vehicle)/the electromotor controller (for the electric vehicle) sets the gearbox to the “Park” gear.

At step 1009, the transmission system (for the fuel vehicle)/the electromotor controller (for the electric vehicle) sends a signal for disengaging the parking cable to the electrical parking brake.

At step 1010, the electrical parking brake disengages the parking cable and feeds back the state of the parking cable.

At step 1011, it is detected whether the transmission system (for the fuel vehicle)/the electromotor controller (for the electric vehicle) receives the signal indicating that the parking cable is disengaged within a predetermined time period such as 2 seconds. If yes, the process 1000 executes step 1012, if no, the process 1000 returns to step 1006.

At step 1012, the transmission system (for the fuel vehicle)/the electromotor controller (for the electric vehicle) sets the gearbox to the “Reverse” gear.

At step 1013, the transmission system (for the fuel vehicle)/the electromotor controller (for the electric vehicle) controls the vehicle to reverse at a speed lower than the predetermined threshold speed (for example, 2 km/h).

Briefly, when a user presses down the backward key, the gearbox is switched to the “Reverse” gear, the parking cable of the electrical parking brake is disengaged, and the vehicle moves backward. If the user releases the backward key, the parking cable of the electrical parking brake is engaged; the gearbox is set to the “Park” gear, and the vehicle stops.

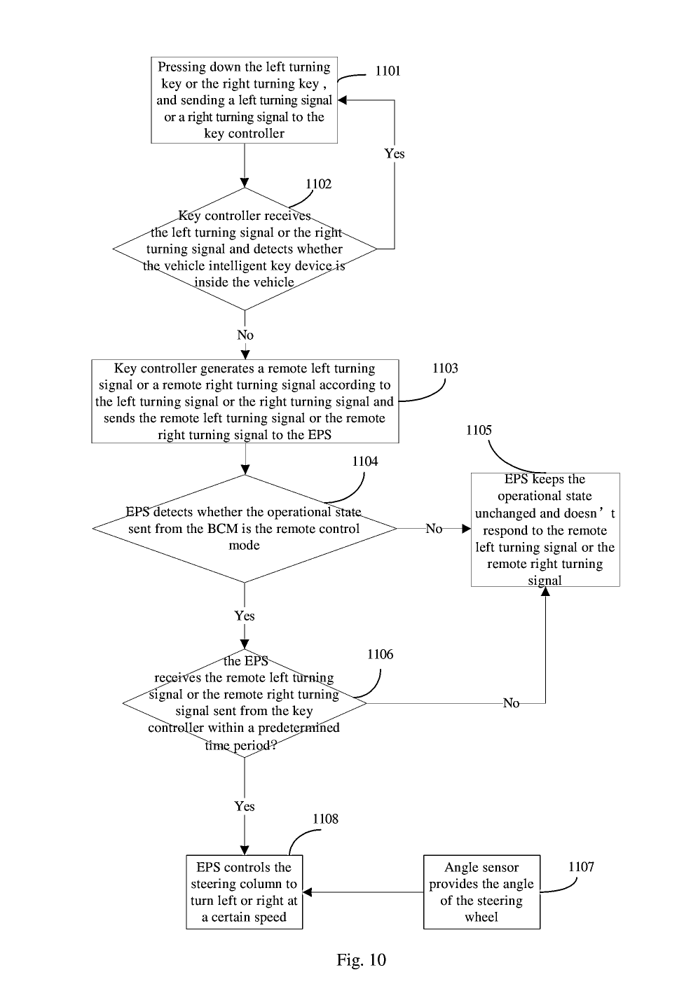

FIG. 10 is a flow chart of a process 1100 for controlling the vehicle to turn left or right according to an embodiment of the present disclosure. As shown in FIG. 10, after the vehicle enters the remote control mode, controlling the vehicle to turn left or right further comprises the following steps.

At step 1101, the left turning key of the vehicle intelligent key device or the right turning key of the vehicle intelligent key device is pressed down, and a left turning signal or a right turning signal is sent to the key controller of the vehicle.

At step 1102, the key controller receives the left turning signal or the right turning signal and detects whether the vehicle intelligent key device is inside the vehicle. If yes, the process 1100 returns to step 1101, if no, the process 1100 then executes step 1103.

At step 1103, the key controller generates a remote left turning signal or a remote right turning signal according to the left turning signal or the right turning signal and sends the remote left turning signal or the remote right turning signal to the electric power steering module.

At step 1104, the electric power steering module detects whether the operational state sent from the body control module is the remote control mode. If yes, the process 1100 executes step 1106; if no, the process 1100 then executes step 1105.

At step 1105, the electric power steering module keeps the operational state of the vehicle unchanged and does not respond to the remote left turning signal or the remote right turning signal.

At step 1106, it is detected whether the electric power steering module receives the remote left turning signal or the remote right turning signal sent from the key controller within a predetermined time period (for example, 100 ms). If no, the process 1100 executes step 1105; if yes, the process 1100 then executes step 1108.

At step 1107, the angle sensor provides the angle of the steering wheel, that is, the angle sensor detects the rotation angle of the steering wheel and feeds back the rotation angle to the electric power steering module.

At step 1108, the electric power steering module controls the steering column to turn left or right at a certain speed.

Briefly, when a user presses down the left turning key, the electric power steering module controls the steering wheel to turn left; and if the user releases the left turning key, the steering wheel stops turning left. When a user presses down the right turning key, the electric power steering module controls the steering wheel to turn right; and if the user releases the right turning key; the steering wheel stops turning right.

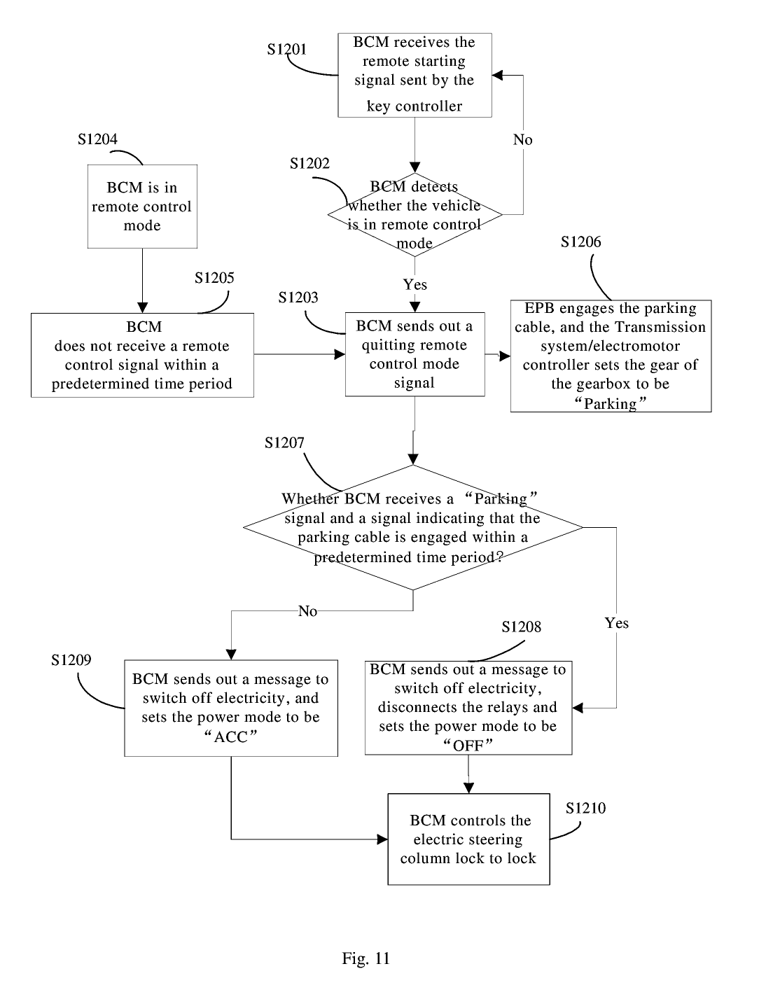

FIG. 11 is a flow chart of a process 1200 for controlling a vehicle to quit the remote control mode according to an embodiment of the present disclosure. As shown in FIG. 11, controlling the vehicle to quit the remote control mode may comprise following steps.

At step 1201, the body control module receives the remote starting signal sent from the key controller indicating the starting key 501 is shortly pressed down.

At step 1202, the body control module detects whether the vehicle is in the remote control mode. If yes, the process 1200 executes step 1203; if no, the process 1200 then returns to step 1201.

At step 1203, the body control module sends out a quit remote control mode signal.

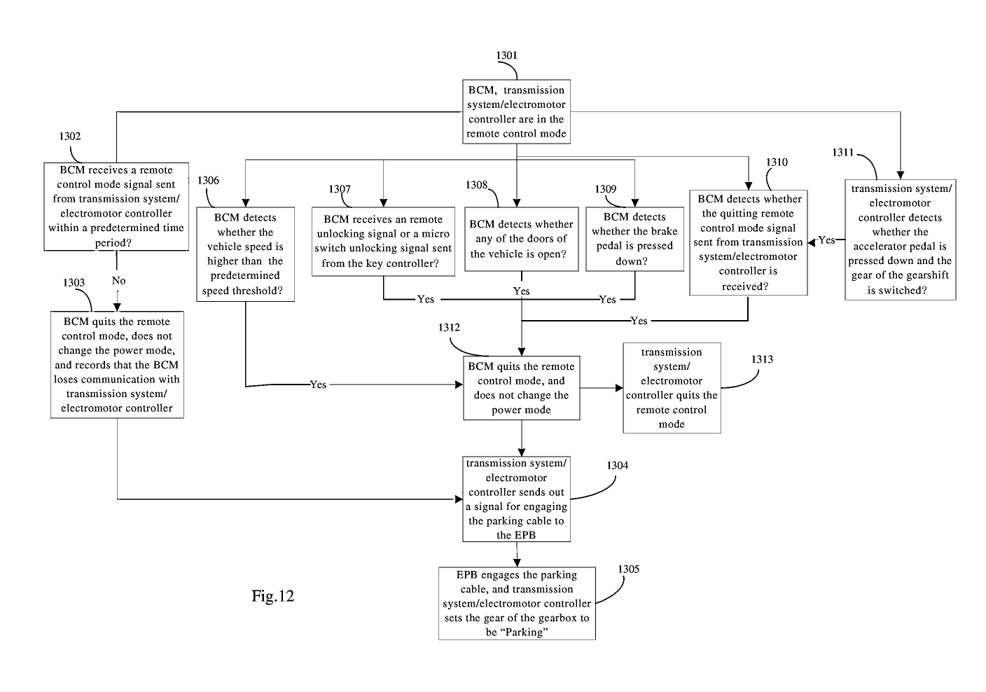

Consistent with embodiments of the present disclosure, other scenarios may also trigger the execution of step 1203. For example, as shown in FIG. 12, at step 1204, the vehicle 101 is already in the remote control mode.

At step 1205, it is detected that the body control module does not receive a remote forward signal, a remote backward signal, or a remote turning signal within a predetermined time period (for example, 10 minutes). As a result, the process proceeds to step 1203.

At step 1206, the EPB engages the parking cable, and the transmission system (for a fuel vehicle)/the electromotor controller (for an electric vehicle) sets the gear of the gearbox to “Park”.

At step 1207, it is detected whether the body control module receives a “Parking” signal and a signal indicating that the parking cable is engaged within a predetermined time period (for example, 2 seconds). If yes, goes to step 1208, if no, goes to step 1209.

At step 1208, the body control module sends out a message to turn off electricity, disconnects the ACC relay, the IG1 relay, and the IG3 relay, and sets the power mode to “OFF”.

At step 1209, the body control module sends out a message to turn off electricity, and sets the power mode to “ACC”.

At step 1210, the body control module controls the electric steering column lock 203 to lock.

FIG. 12 is a flow chart of a process 1300 for controlling the vehicle to quit the remote control mode according to another embodiment of the present disclosure. As shown in FIG. 12, controlling the vehicle to quit the remote control mode may comprise the following steps.

At step 1301, the BCM, the transmission system (for a fuel vehicle)/the electromotor controller (for an electric vehicle) are in the remote control mode.

At step 1302, it is detected that the BCM does not receive a remote control mode signal (indicating the vehicle is in the remote control mode) sent by the transmission system (for a fuel vehicle)/the electromotor controller (for an electric vehicle) within a predetermined time period (for example, 2 seconds). As a result, the process proceeds to step 1303.

At step 1303, the BCM quits the remote control mode (under normal driving mode), does not change the power mode, and records that the BCM loses communication with the transmission system (for a fuel vehicle)/the electromotor controller (for an electric vehicle). The process proceeds to step 1304.

At step 1304, the transmission system (for a fuel vehicle)/the electromotor controller (for an electric vehicle) sends out a engage parking cable signal to the EPB.

At step 1305, the EPB engages the parking cable, and the transmission system (for a fuel vehicle)/the electromotor controller (for an electric vehicle) sets the gear of the gearbox to “Park”.

Consistent with embodiments of the present disclosure, there are other scenarios that may trigger the execution of step 1304, as described in more detail below

At step 1306, the BCM 202 detects that the vehicle speed is higher than the speed threshold (for example, 2 km/h) or the speed signal is failed to be detected. The process proceeds to step 1312.

At step 1307, the BCM receives a remote unlocking signal or a micro switch unlocking signal sent by the key controller. The process proceeds to step 1312.

At step 1308, the BCM detects that at least one of the vehicle doors is open. The process proceeds to step 1312.

At step 1309, the BCM detects that the brake pedal is pressed down. The process proceeds to step 1312.

At step 1310, the BCM receives a quit remote control mode signal sent by the transmission system (for a fuel vehicle)/the electromotor controller (for an electric vehicle). The process proceeds to step 1312.

In addition, when the transmission system (for a fuel vehicle)/the electromotor controller (for an electric vehicle) detects that the accelerator pedal is pressed down and the gear of the gearshift is switched (step 1311), the process also proceeds to step 1310.

At step 1312, the BCM quits the remote control mode (under normal driving mode), and does not change the power mode. On the one hand, a engage parking cable signal is sent to the EPB 208 (step 1304). On the other hand, the transmission system (for a fuel vehicle)/the electromotor controller (for an electric vehicle) quits the remote control mode (step 1313).

The steps 1302, 1306, 1307, 1308, 1309, 1310, and 1311 may be executed simultaneously or sequentially, and the order of these steps could be changed. Furthermore, when one of the conditions described in these steps is satisfied, the vehicle quits the remote control mode, and the other steps may not be executed.

In brief, the vehicle quits the remote control mode if any one of the following conditions is satisfied.
(1) No remote controlling operation is implemented over a predetermined time period (for example, 10 minutes). The parking cable of the electrical parking brake is engaged, the gearbox is set to the “Park” gear, the vehicle stops and shuts down, and the electric steering column lock is locked.
(2) The starting key is pressed down briefly. The parking cable of the electrical parking brake is engaged, the gearbox is set to the “Park” gear, the vehicle stops and shuts down, and the electric steering column lock is locked.
(3) The vehicle intelligent key device is unlocked or a micro switch is unlocked to open doors of the vehicle. The parking cable of the electrical parking brake is engaged; the gearbox is set to the “Park” gear, the vehicle stops but does not shut down.
(4) An accelerator pedal or a brake pedal is pressed down. The gear of a gear lever is changed to quit the remote control mode, and the vehicle does not shut down.
(5) The vehicle speed is higher than the predetermined threshold speed, for example, 2 km/h, or a vehicle speed signal is faulty. At this time, the vehicle quits the remote control mode, but the vehicle does not shut down.

It is advantageous for quitting the remote control mode in the cases that: the vehicle is driven by the user; the user forgets to shut down the vehicle, causing the vehicle to remains in the remote control mode for a long time; the vehicle loses the remote control function as the direction control key fails.

With the remote control method for driving a vehicle according to embodiments of the present disclosure, users may control the vehicle to start, move forward or backward, turn left or right within a visual range (for example, 10 meters) outside the vehicle. The control operation is also simple. Therefore, it is convenient for a user to park or take a vehicle in a narrow space.

Reference throughout this specification to “an embodiment,” “some embodiments,” “one embodiment,” or “embodiments,” means that a particular feature, structure, material, or characteristic described in connection with the embodiment or example is included in at least one embodiment or example of the present disclosure. Thus, the appearances of the phrases such as “in some embodiments,” “in one embodiment,” “in embodiments,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

What is claimed is:

1. A passenger vehicle, comprising:
a vehicle intelligent key device, configured to send a starting signal and a control signal; and
a passenger vehicle, configured to receive the starting signal and the control signal, to start a remote control mode according to the starting signal, and to control the passenger vehicle according to the control signal,
wherein the passenger vehicle comprises an automatic transmission and an electrical parking brake, the automatic transmission is configured to receive the control signal, and to control the electrical parking brake to disengage a parking cable of the passenger vehicle and to set a gearbox to a “Drive” state or a “Reverse” state when the passenger vehicle is in the remote control mode.

2. The passenger vehicle according to claim 1, wherein the automatic transmission includes a dual clutch transmission.

3. The passenger vehicle according to claim 1, wherein the passenger vehicle further comprises:
a key controller, configured to receive the starting signal and the control signal and to generate a remote starting signal and a remote control signal according to the starting signal and the control signal;
a body control module, configured to receive the remote starting signal and the remote control signal, to control the passenger vehicle to power on, to start the remote control mode according to the remote starting signal and to generate an unlocking signal;
an electric steering column lock, configured to receive the unlocking signal sent from the body control module and to unlock a steering wheel of the passenger vehicle according to the unlocking signal;
a gateway, configured to communicate with the key controller, the body control module and the electric steering column lock respectively; and
an engine control module, configured to communicate with the gateway and to control an engine of the passenger vehicle to start according to the remote starting signal transmitted by the gateway.

4. The passenger vehicle according to claim 3, wherein the automatic transmission is further configured to communicate with the gateway and to control the gear of the gearbox of the passenger vehicle to switch and to generate a parking control signal according to the remote control signal transmitted by the gateway; the electrical parking brake is configured to communicate with the gateway and to control the passenger vehicle to park according to the parking control signal transmitted by the gateway.

5. The passenger vehicle according to claim 1, wherein the starting signal includes a high-frequency starting signal and the control signal includes a high-frequency control signal.

6. The passenger vehicle according to claim 5, wherein the passenger vehicle further comprises a high-frequency receiving device configured to receive the high-frequency starting signal and the high-frequency control signal, to demodulate the high-frequency starting signal and the high-frequency control signal so as to obtain the starting signal and the control signal, and to send the starting signal and the control signal to the key controller.

7. The passenger vehicle according to claim 3, wherein the key controller is further configured to detect whether the vehicle intelligent key device is outside the passenger vehicle after receiving the starting signal and the control signal, and to send the remote starting signal and the remote control signal to the body control module when the vehicle intelligent key device is outside the passenger vehicle.

8. The passenger vehicle according to claim 3, wherein the body control module is further configured to detect a state of the electrical parking brake and the gear of the gearbox of the passenger vehicle

9. The passenger vehicle according to claim 3, wherein when the state of the electrical parking brake is “normal” and the gear of the gearbox of the passenger vehicle is “Park,” the engine control module and the key controller perform a pairing operation and if the engine control module and the key controller are paired, the engine control module controls the engine to start.

10. A passenger vehicle intelligent key device, comprising:
a starting key;
a direction control key;
a wireless communication module, configured to communicate with a passenger vehicle wirelessly; and
a controlling module, connected to the starting key, the direction control key and the wireless communication module respectively, configured to send a starting signal or a control signal to the passenger vehicle when the starting key or the direction control key is activated.

11. The passenger vehicle intelligent key device according to claim 10, wherein the direction control key comprises at least one of a left turning key, a right turning key, a forward key and a backward key.

12. The passenger vehicle intelligent key device according to claim 10, further comprising a locking key and an unlocking key connected to the control module,
wherein the control module is configured to control the wireless communication module to send a locking signal to the passenger vehicle when the locking key is activated and to send an unlocking signal to the passenger vehicle when the unlocking key is activated.

13. The passenger vehicle intelligent key device according to claim 10, further comprising a transponder configured to communicate with the passenger vehicle when the wireless communication module is interfered.

14. A remote control method for driving a passenger vehicle, comprising steps of:
generating a starting signal and a control signal by a passenger vehicle intelligent key device;
sending the starting signal and the control signal to a passenger vehicle;
starting a remote control mode of the passenger vehicle according to the starting signal; and
controlling the passenger vehicle to move forward or backward at a speed lower than a predetermined vehicle threshold speed according to the control signal when the passenger vehicle is in the remote control mode.

15. The remote control method according to claim 14, wherein the starting signal includes a high-frequency starting signal and the control signal includes a high-frequency control signal.

16. The remote control method according to claim 15, further comprising:
receiving the high-frequency starting signal and the high-frequency control signal from the vehicle intelligent key device by a high-frequency receiving device of the passenger vehicle;
demodulating the high-frequency starting signal and the high-frequency control signal by the high-frequency receiving device so as to obtain the starting signal and the control signal;
sending the starting signal and the control signal to a key controller of the passenger vehicle by the high-frequency receiving device;
generating a remote starting signal and a remote control signal according to the starting signal and the control signal by the key controller.

17. The remote control method according to claim 16, further comprising:
detecting whether the vehicle intelligent key device is outside the passenger vehicle after the key controller receives the starting signal or the control signal; and
if yes, sending the remote starting signal or the remote control signal to a body control module of the passenger vehicle.

18. The remote control method according to claim 16, further comprising:
detecting a state of an electrical parking brake and a gear of a gearbox of the passenger vehicle after the body control module receives the remote starting signal;
pairing an engine control module and the key controller when the state of the electrical parking brake is “normal” and the gearbox is set to a “Park” gear; and
starting an engine of the passenger vehicle after engine control module and the key controller are paired.

19. The remote control method according to claim 16, wherein the remote control signal is any one of a remote forward signal and a remote backward signal.

20. The remote control method according to claim 19, further comprising:
detecting whether the engine of the passenger vehicle is in the remote control mode by an automatic transmission of the passenger vehicle when the remote forward signal is received by the automatic transmission;
if yes, controlling the electrical parking brake to disengage the parking cable; and
setting the gearbox to a “Drive” state by the automatic transmission when a state of the parking cable is fed from the electrical parking brake.

21. The remote control method according to claim 19, further comprising:
detecting whether the engine of the passenger vehicle is in the remote control mode by an automatic transmission of the passenger vehicle when the remote backward signal is received by the automatic transmission;
if yes, controlling the electrical parking brake to disengage the parking cable; and
setting the gearbox to a “Reverse” state by the automatic transmission when a state of the parking cable is fed from the electrical parking brake.
